(19) United States
(12) Patent Application Publication
(10) Pub. No.: US 2012/0097823 A1
(43) Pub. Date: Apr. 26, 2012

(54) HARDENED DATA RECORDING SYSTEM FOR DRILLING RIGS AND OTHER DRILLING EQUIPMENT

(75) Inventors: David Carl Murray, Austin, TX (US); Ted Louis Christiansen, Houston, TX (US)

(73) Assignee: NATIONAL OILWELL VARCO, L.P., Houston, TX (US)

(21) Appl. No.: 13/274,500

(22) Filed: Oct. 17, 2011

Related U.S. Application Data
(60) Provisional application No. 61/405,872, filed on Oct. 22, 2010.

(51) Int. Cl. F16M 13/02; G06F 17/40

(52) U.S. Cl. 248/550; 702/9

(57) ABSTRACT

A system for recording data associated with a drilling rig is disclosed. In one embodiment, such a system includes one or more hardened memory devices and a memory interface unit to receive one or more data streams containing drilling data. The memory interface unit is configured to extract the drilling data from the data streams and store the drilling data on the one or more hardened memory devices. If desired, the hardened memory devices may be distributed across a drilling rig to increase the probability that recorded data will survive a catastrophic event. Optionally, the system includes a communication device to enable communication with a remote site.

### CROSS-REFERENCE TO RELATED APPLICATIONS

This patent application claims priority to U.S. provisional patent application Ser. No. 61/405,872 filed on 22 Oct. 2010 and entitled “HARDENED DATA RECORDING DEVICE FOR DRILLING RIGS AND OTHER DRILLING EQUIPMENT.”

### BACKGROUND

1. Field

This disclosure relates to systems and methods for reliably recording drilling data originating at drilling rigs, such as offshore drilling rigs.

2. Background of the Related Art

Energy-related disasters, such as the one that occurred with the Deepwater Horizon drilling platform, have brought such disasters to the forefront of the nation's consciousness. As was observed with the Deepwater Horizon, such catastrophic events can have devastating and far-reaching consequences on the environment, on the economy, particularly in the immediate area of the disaster, on jobs for those in the oil-and-gas industry or serving the oil-and-gas industry, and on stockholders having an ownership stake in oil-and-gas drilling companies or other companies dependent thereon. Such catastrophic events can also become political issues that can have significant legal and legislative consequences regardless of the actual real-world impacts caused thereby.

One positive outcome of catastrophic events is that they often provide an impetus for improving systems and technologies needed to prevent such catastrophes in the future. Nevertheless, in order to improve such systems and technologies, data is needed to determine the root causes of the catastrophe. Unfortunately, this data is often very hard to obtain. Catastrophic events, such as occurred with the Deepwater Horizon, may be of such a violent nature that computers and other systems used to store and gather data are rendered entirely useless, if they can even be located. Such catastrophic events may also interrupt communication links with satellites or other off-site equipment to severely hinder or terminate off-site data-gathering capability. Often, events that occur just prior to a catastrophic event (on the order of seconds before the catastrophic event) or events that take place as the catastrophic event is developing are the most important events to record. Unfortunately, data associated with these events is often lost since the data may still be in flight (i.e., not yet recorded) or not yet uploaded to a remote site when the catastrophic event occurs.

In view of the foregoing, systems and methods to reliably record data originating from drilling rigs and other drilling equipment are needed. Preferably, such systems and methods would reliably record data even where the data is generated in close temporal proximity to a catastrophic event. Further, systems and methods to access the recorded data without having to physically visit the site of the catastrophic event are needed. If desired, such data-recording capability could also be used advantageously to record data about smaller, non-catastrophic events.

### SUMMARY

The techniques herein have been developed in response to the present state of the art and, in particular, in response to the problems and needs in the art that have not yet been fully solved by currently available systems and methods. Accordingly, these techniques have been developed to provide systems and methods for reliably recording data associated with a drilling rig or other drilling and/or production equipment. The features and advantages of the invention will become more fully apparent from the following description and appended claims, or may be learned by practice of the invention as set forth hereinafter.

Consistent with the foregoing, a system for recording data associated with a drilling rig is disclosed herein. In one embodiment, such a system includes one or more hardened memory devices and a memory interface unit to receive one or more data streams containing drilling data. The memory interface unit is configured to extract the drilling data from the data streams and store the drilling data on the one or more hardened memory devices. If desired, the hardened memory devices may be distributed across a drilling rig to increase the probability that recorded data will survive a catastrophic event. Optionally, the system includes a communication device to enable communication with a remote site.

Additionally, a release device may be included in the system to automatically release the hardened memory device from a structure upon occurrence of an event to ensure the hardened memory device is not damaged during the event or during recovery and/or rescue operations in response to the event.

The system may also include a beacon device, coupled to the hardened memory device, to aid in locating the hardened memory device, a release device configured to release the hardened memory device from a structure upon occurrence of an event. The release device may be manually actuatable to release the hardened memory device from the structure upon occurrence of an event. The release device may include a disconnector for disconnecting the hardened memory device from the drilling rig and a release mechanism comprising an arm having a cradle for supporting the hardened memory device. The arm may be selectively movable between a secure position and a release position such that the hardened memory device is released a distance from the drilling rig. The disconnector may be a guillotine cutter for severing a communication link between the hardened memory device and the drilling rig.

The system may also include a communication device enabling communication with the hardened memory device from a remote location. The communication device may enable communication with the hardened memory device through the memory interface unit. The communication device may enable direct communication with the hardened memory device, bypassing the memory interface unit. The communication may be wired or wireless communication.

The memory interface unit may be hardened. The hardened memory device may be one of a plurality of hardened memory devices, each storing redundant drilling data. The hardened memory device may be a circular memory configured to overwrite less recent drilling data with more recent drilling data. The system may also include a battery backup to supply backup power to at least one of the memory interface unit and the hardened memory device. The data stream may include a plurality of data streams containing different types of drilling data. Each of the different types of drilling data is stored in separate partitions on the hardened memory device. The different types of drilling data may be multiplexed and stored together on the hardened memory device. The drilling data may include at least one of: blowout preventer data, drilling flight recorder data, control system data, electronic drilling recorder data, pit volume totalizer data, sensor data, and wellsite information transfer specification data. The system may also include a human machine interface to enable a human to interact with the memory interface unit, and/or structures to enable at least one of the memory interface unit and the at least one hardened memory device to float in water.

In another aspect the disclosure relates to a system for recording data associated with a drilling rig. The system includes a hardened memory device; a memory interface unit to receive at least one data stream containing drilling data, extract the drilling data from the at least one data stream, and store the drilling data on the hardened memory device; and a communication device enabling communication with the hardened memory device from a remote location. The communication device may enable communication with the hardened memory device through the memory interface unit. The communication device may enable direct communication with the hardened memory device, bypassing the memory interface unit.

In yet another aspect, the disclosure relates to a system for recording data associated with a drilling rig. The system includes a hardened memory device; a memory interface unit to receive at least one data stream containing drilling data, extract the drilling data from the at least one data stream, and store the drilling data on the hardened memory device; a beacon device to aid in locating the hardened memory device; and a release device configured to automatically release the hardened memory device from a drilling rig upon occurrence of an event. The release device may be a hydrostatic release device. The memory interface unit may be further configured to format the drilling data for storage on the hardened memory device. The release device includes a disconnector for disconnecting the hardened memory device from the drilling rig and a release mechanism comprising an arm having a cradle for supporting the hardened memory device. The arm may be selectively movable between a secure position and a release position such that the hardened memory device is released a distance from the drilling rig. The disconnector may include a guillotine cutter for severing a communication link between the hardened memory device and the drilling rig.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 a high-level diagram showing one example of a data recording system used with an offshore drilling rig;

FIG. 2 is a high-level diagram showing one embodiment of the data recording system after a catastrophic event has occurred;

FIG. 3 is a high-level diagram showing another embodiment of the data recording system after a catastrophic event has occurred;

FIG. 4 is a high-level block diagram of various possible components of a data recording system in accordance with the invention;

FIG. 5 is a high-level diagram showing one embodiment of a data recording system able to wirelessly communicate with a remote site;

FIG. 6 is a high-level block diagram showing one embodiment of a data recording system able to communicate with a remote site through the memory interface unit; and

FIG. 7 is a high-level block diagram showing hardened memory devices configured to communicate directly with a remote site.

FIG. 8 is a schematic, perspective view of an offshore drilling rig having two data recording systems, each deployable by a release device.

### DETAILED DESCRIPTION

It will be readily understood that the components of the disclosure, as generally described and illustrated in the Figures herein, could be arranged and designed in a wide variety of different configurations. Thus, the following more detailed description of the embodiments, as represented in the Figures, is not intended to limit the scope of the disclosure, but is merely representative of certain examples of presently contemplated embodiments in accordance with the invention. The presently described embodiments will be best understood by reference to the drawings, wherein like parts are designated by like numerals throughout.

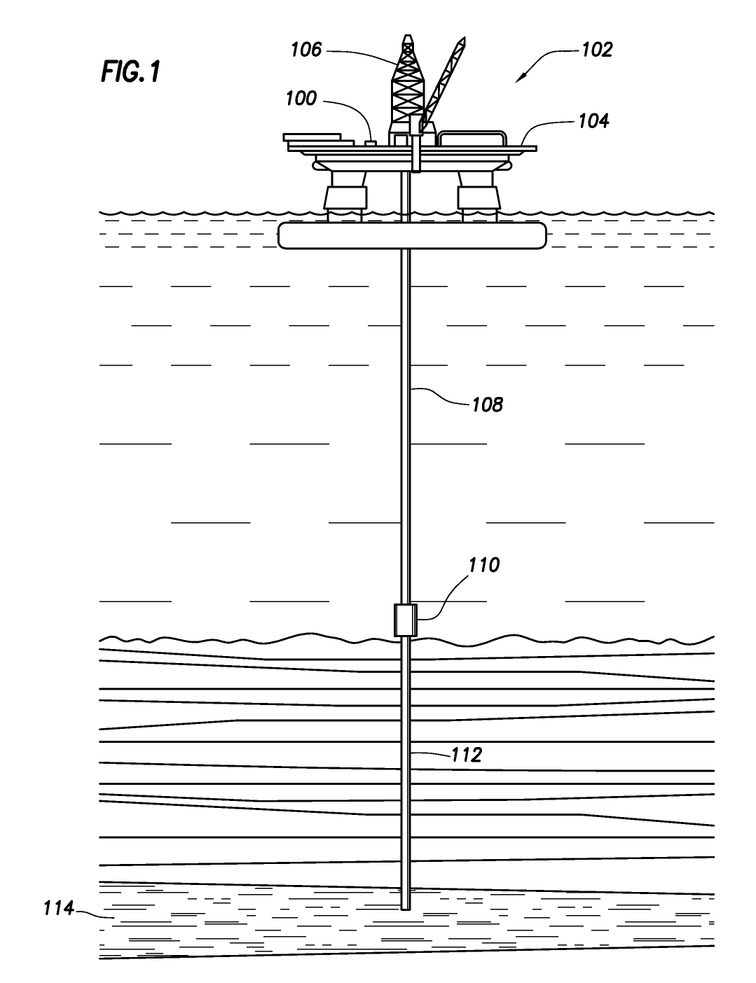

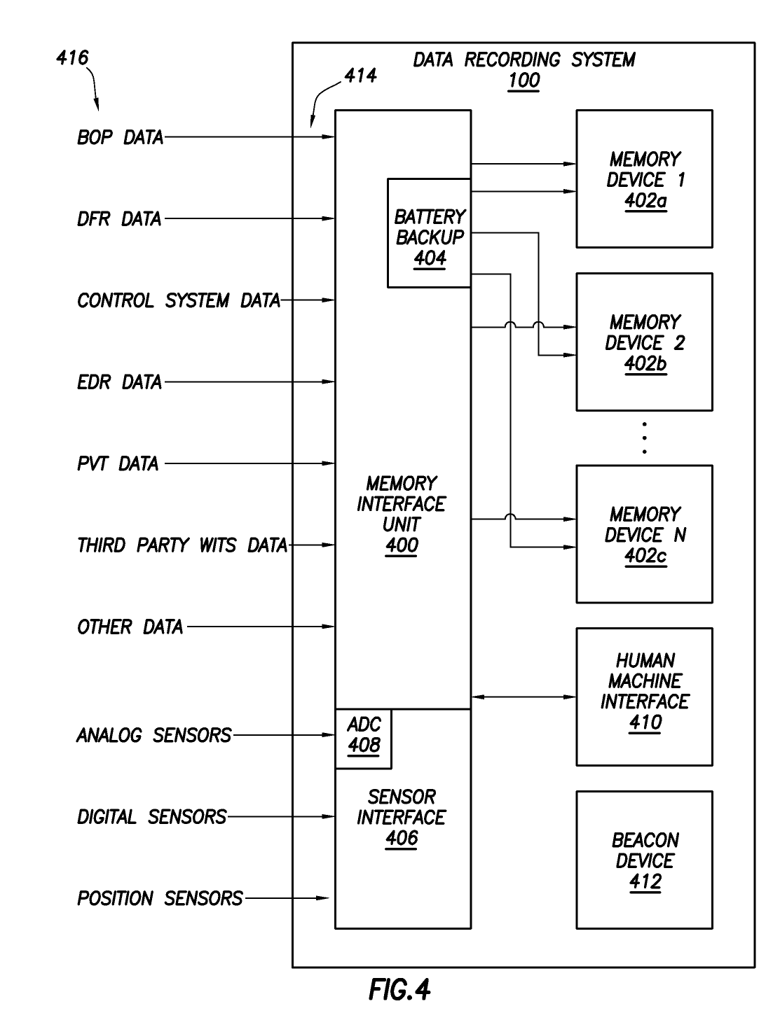

Referring to FIG. 1, one example of a hardened data recording system 100 used with an offshore drilling rig 102 is illustrated. The hardened data recording system 100 may be used to record various types of data associated with the offshore drilling rig 102. Various types of data that can be collected by the hardened data recording system 100 will be discussed in association with FIG. 4. One of skill in the art will recognize that a drilling rig 102 can take on many different forms. In the illustrated embodiment, the drilling rig 102 is a semi-submersible offshore drilling rig 102 that includes, among other equipment, a platform 104 and derrick 106. Once a well 112 is established, the drilling rig 102 extracts hydrocarbons 114, such as oil or gas, through the well 112 and a riser 108. A blowout preventer 110 may be used to prevent blowouts caused by pressure kicks or other erratic or extreme pressures encountered in the well 112.

For the purposes of this disclosure, the phrase “drilling rig” is used broadly to refer to a wide variety of different drilling rigs, platforms, and related equipment, whether used for drilling or production purposes. For example, an offshore drilling rig 102 may include conventional fixed platforms, compliant tower rigs, vertically moored tension leg and mini-tension leg platforms, jack-up rigs, semi-submersible platforms, drill ships, spar platforms, floating production, storage, and offloading facilities, sub-sea completion and tie back to host facility platforms, and the like. Thus, the phrase “drilling rig” is used to refer to a wide variety of different types of drilling and production equipment, whether offshore or land-based. The term “hardened” is used to mean that a device is rendered substantially impervious or resistant to elements, such as fire, water, pressure, vibration, crushing, or the like. “Hardening” a device may be provided by one or more of armor, hermetic seals, padding, shock absorbers, reducing or eliminating moving parts, or the like.

The hardened data recording system 100 illustrated in FIG. 1 may be mounted to various parts of the drilling rig 102, and is not limited to mounting in any particular location. Preferably, the hardened data recording system 100 is mounted or positioned as close to various data sources as possible, to reduce propagation delays. Where the hardened data recording system 100 includes a beacon device, as will be described in more detail hereafter, the hardened data recording system 100 should be mounted in such a location that the signal emitted by the beacon device can be detected by search-and-recovery equipment and personnel. The hardened data recording system 100 should also be mounted in such a way that it can be readily retrieved when located. As will be appreciated by those skilled in the art, an offshore drilling rig 102 that sinks to bottom of an ocean or other body of water can be very difficult to access, depending on the depth of the rig 102. Thus, the hardened data recording system 100 may be mounted in such a way that search-and-recovery equipment and personnel can readily locate and/or retrieve the system 100.

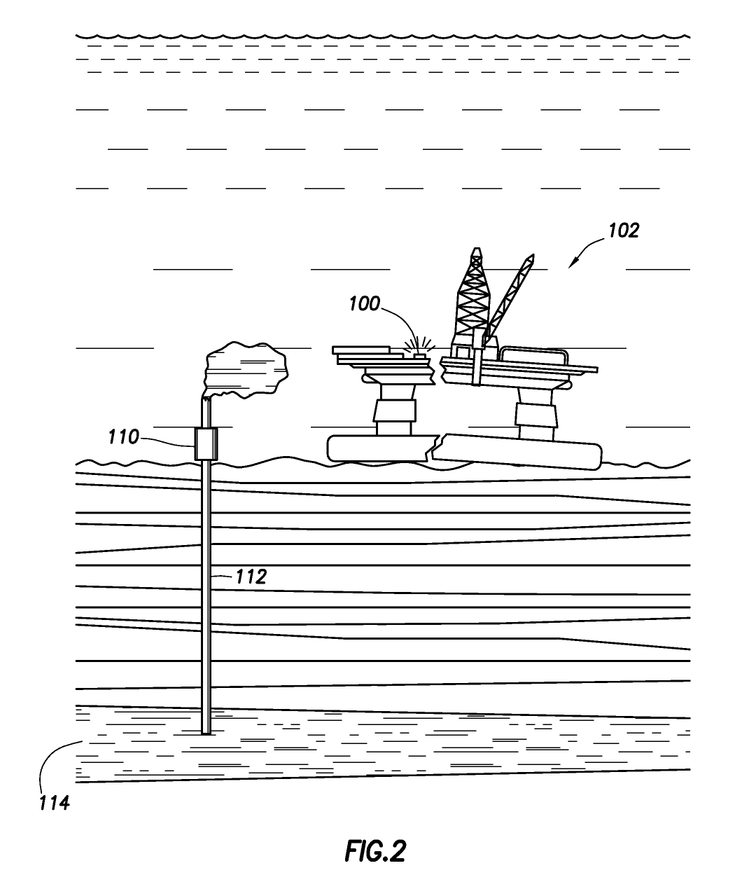

Referring to FIG. 2, when a catastrophic event, such as an explosion occurs, such as occurred on the Deepwater Horizon drilling platform, all or part of a drilling rig 102 may become difficult to access due to damage or its position on the sea floor. In selected embodiments, such an event may be used to activate a beacon device in the data recording system 100 or otherwise attached to the data recording system 100. This will cause the beacon device to emit a signal, such as an acoustic signal or flashing light. This will preferably enable search-and-recovery equipment and personnel to locate the data recording system 100. In the illustrated embodiment, the data recording system 100 remains attached to the drilling rig 102 until it can be located and retrieved by search-and-recovery equipment or personnel, such as with a submarine or other equipment. In such an embodiment, the hardened data recording system 100 would be designed to withstand the pressures, temperatures, or other conditions encountered in deep-water environments.

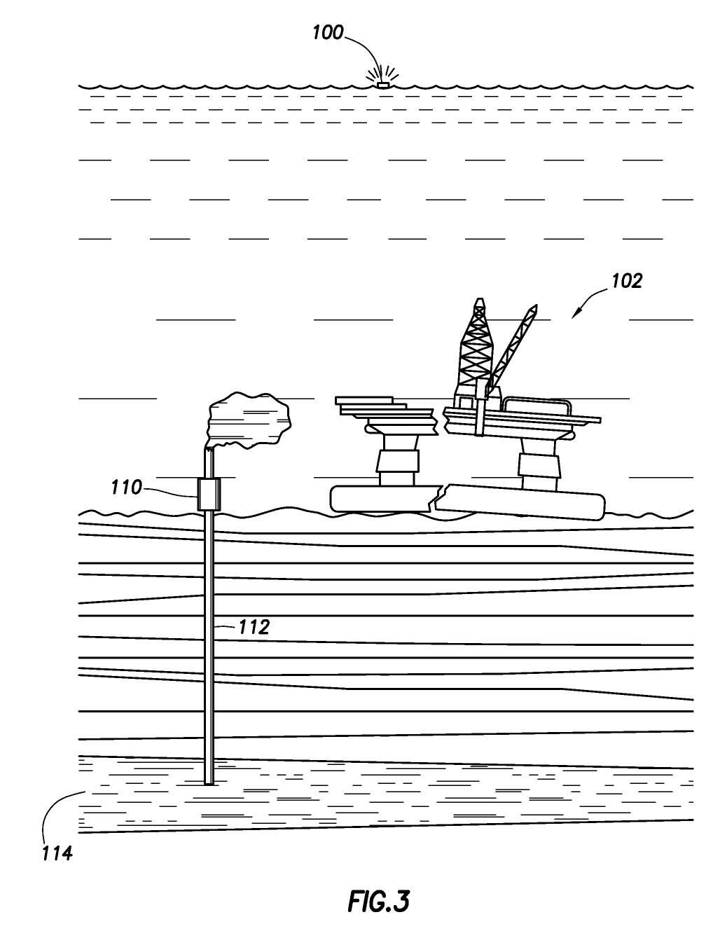

Referring to FIG. 3, in certain embodiments, a data recording system 100 may be tethered to the drilling rig 102 under normal operating conditions. However, the data recording system 100 may be configured to detach or separate from the drilling rig 102 upon occurrence of a catastrophic event or other event. For example, a release device, such as a hydrostatic release device, may be used to release the data recording system 100 from the drilling rig 102 in the event the data recording system 100 has entered water or has descended to a specified water depth or experienced a specified amount of water pressure. Alternatively, or additionally, the release device may allow a user to manually release the data recording system 100 or an automated system to automatically release the data recording system 100 in response to a catastrophic or other event as will be described further herein. In certain embodiments, the data recording system 100 is fabricated from buoyant materials or attached to buoyant materials or structures to allow the data recording system 100 to float upon release. This will allow the data recording system 100 to float to the surface where it may be retrieved by search-and-recovery equipment and/or personnel. A beacon device attached to or incorporated into the data recording system 100 may provide assistance in locating and retrieving the data recording system 100.

Referring to FIG. 4, one embodiment of a hardened data recording system 100 in accordance with the invention is illustrated. As shown, in certain embodiments, the data recording system 100 includes a memory interface unit 400 and one or more memory devices 402a-c. The memory interface unit 400 includes one or more inputs 414 to receive data streams containing various types of drilling data 416. The memory interface unit 400 extracts the drilling data 416 from the incoming data streams and formats it in such a way that it can be stored on the memory devices 402a-c. In certain embodiments, the memory interface unit 400 utilizes a deterministic real-time operating system (RTOS) to increase the reliability of the memory interface unit 400. Preferably, the memory interface unit 400 is a solid-state device with no or few moving parts (e.g., rotating media such as hard drives) to further increase the reliability and robustness of the memory interface unit 400.

The memory devices 402a-c are preferably non-volatile solid-state memory devices, such as flash memory devices or other suitable memory devices. The memory devices 402a-c may function as circular buffers, such that new incoming data overwrites older data. In this way, the memory devices 402a-c will store the most recent data collected. The amount of data stored and the time period of stored data (i.e., whether the memory devices 402a-c store minutes, hours, days, or weeks of data, etc.) may vary based on the size of the memory devices 402a-c and the amount of data in the incoming data streams 416. In selected embodiments, the amount of memory 402a-c may be increased or reduced by adding or removing memory devices 402a-b to and from the data recording system 100.

In selected embodiments, data that is received in the incoming data streams 416 is stored on different partitions on the memory devices 402a-c. For example, blowout preventer (BOP) data may be stored in a first partition while drilling flight recorder (DFR) data is stored on a different partition, and so forth. In other embodiments, the various data streams 416 are multiplexed or combined for storage together on the memory devices 402a-c. This data may then be de-multiplexed or separated if and when it is retrieved from the memory devices 402a-c. The manner in which the memory devices 402a-c are used may also vary. For example, the memory devices 402a-c may be configured to store different data or store duplicate copies of the same data for redundancy.

In certain embodiments, the drilling data in the data streams 416 originates from controllers, such as programmable logic controllers (PLCs) or embedded system controllers, present at various locations on the drilling rig 102 or downhole such as along a drill string or production well. Preferably, the memory interface unit 400 is placed in close proximity to such controllers with a communication path that is as direct or substantially direct as possible. This will ensure that data is captured as close to its source as possible. This will also reduce or eliminate communication paths through servers, computers, or other devices (which may use less reliable rotating storage media or other less reliable components) that may be potential points of failure and data loss. Nevertheless, the data recording system 100 may also collect and store data from less-reliable servers, computers, or devices to back up the data contained thereon and ensure that such data is able to survive a catastrophic event.

As shown, the memory interface unit 400 is configured to receive different types of data 416. This data 416 may include, among other data, blowout preventer (BOP) data and DFR data. The data 416 may also include control system data, such as CYBERBASE™ control system data, AMPHION™ control systems data, or the like. Such control systems may be used by an operator to control various drilling tools (e.g., top drives, drawworks, mud pumps, roughnecks, pipe-handling systems, etc.) to control parameters, such as the rate of penetration, the torque applied to the bit, the mud flow rate, and the like, during the drilling process. The control system data may be recorded to determine, among other things, how an operator's actions may have contributed to an event, catastrophic or otherwise.

The data 416 may also include electronic drilling recorder (EDR) data. The EDR data may include different drilling parameters, such as the location of a block, the location of a drill bit, hole depth, torque applied to the drill bit, weight on bit, rate of penetration, and the like. The data 416 may also include pit volume totalizer (PVT) data, such as RIGSENSE® and SDI data, which may include parameters, such as the volume of mud flowing into and out of a drill string. This PVT data may be very useful to determine if a formation is absorbing mud or if a pressure increase, such as a kick has occurred (since this will likely cause mud to flow out of the drill string at an increased rate). The data 416 may also include third party data transmitted in accordance with the Wellsite Information Transfer Specification (WITS) or the Wellsite Information Transfer Standard Markup Language (WITSML) specification. This type of data may originate from tools, such as measurement-while-drilling (MWD) tools, from third parties.

The data 416 may also include drilling data collected by way of Object Linking Embedding (OLE) for Process Control (OPC), MODBUS™, User Diagram Protocol (UDP) multicast, or the like. In other embodiments, the drilling data 416 includes data from data recorders on the drilling rig 102, such as data from an eHAWK® data recorder. The eHAWK® data recorder in particular may allow service personnel to log into and access drilling data on the eHAWK® data recorder from a remote location. This may allow remote service personnel to analyze drilling data 416 to troubleshoot problems and/or identify trends in the data. Because data recorders, such as the eHAWK® data recorder, may not be hardened devices, data on these data recorders may not survive a catastrophe. Thus, such data may be backed up on the hardened data recording system 100. As will be explained in more detail hereafter, in certain embodiments, the data recording system 100 may be configured to enable remote access of the data contained thereon. This may allow service personnel to access the data without physically visiting the drilling site. The drilling data 416 described in association with FIG. 4 represent just a few non-limiting examples of different types of data 416 that may be collected and stored by the data recording system 100.

In certain embodiments, the memory interface unit 400 includes a sensor interface 406 for interfacing with various types of sensors, such as analog sensors (including, for example, 4-20 mA analog voltage sensors, strain gauges, weight sensors, pressure sensors, temperature sensors, flow sensors, etc.), digital sensors (such as proximity sensors, event sensors, rate sensors, etc.), and position sensors (such as axial encoders, linear displacement sensors, etc.). To interface with analog sensors, the sensor interface 406 may include an analog-to-digital converter (ADC) 408 to convert the incoming analog signals to digital signals.

In certain embodiments, a human-machine interface 410 may be provided to enable a human to interface with the data recording system 100. This human-machine interface 410 may interface with output devices (e.g., monitors, speakers, etc.) or input devices (e.g., keyboards, mice, joy sticks, switches, etc.) Such a human-machine interface 410 may enable an operator to view or change data or settings associated with the data recording system 100. In other embodiments, the human-machine interface 410 may allow firmware or other updates to be uploaded to the memory interface unit 400.

As mentioned previously, the data recording system 100 may include a beacon device 412 to emit a signal, such as an acoustic signal, Radio Frequency (RF) signal, or flashing light. The beacon device 412 may be connected to the same power supply as the memory interface unit 400 and memory devices 402 or have its own power supply. In selected embodiments, the beacon device 412 is configured to emit a signal (i.e., become activated) in response to a catastrophic event or other specified event. For example, the beacon device 412 may begin operating when a primary power supply has been terminated, causing the beacon device 412 to draw power from a backup power supply 404 or its own power supply. In other embodiments, the beacon device 412 is activated in response to a signal from the memory interface unit 400 or from a sensor. For example, the beacon device 412 may be connected to a sensor that activates the beacon device 412 when it detects water or pressure corresponding to a certain water depth. In other embodiments, the beacon device 412 is continually operating, meaning that it is always activated.

As mentioned above, in selected embodiments, the memory interface unit 400 (or recording system 100 in general) includes a battery backup 404. This battery backup 404 may be used to power the memory interface unit 400, memory devices 402a-c, or other components when primary power has been cut off. This will ensure that the data recording system 100 can continue operating when primary power is terminated and other computer systems and satellite communications are no longer operating. This may also ensure that the beacon device 412 can operate after primary power is terminated.

The data recording system 100 may be physically configured in various different ways. For example, in selected embodiments, each of the components 400, 402, 410, 412 are provided on a single-board computer (SBC). The memory devices 402a-c or other components may be permanently attached to the SBC or the SBC may include slots or other connectors where additional memory devices 402 or components can be plugged into or removed from the SBC. In other embodiments, the memory interface unit 400, memory devices 402, and other components are part of the same integrated circuit, such as with systems-on-a-chip. Where the components 400, 402, 410, 412 are integrated on the same circuit board or integrated circuit, the entire data recording system 100 may be hardened as a single unit.

In other embodiments, the memory devices 402a-c, memory interface unit 400, and/or other components are embodied as separate devices (i.e., are not on the same circuit board or integrated circuit). In such embodiments, the components may be hardened separately. For example, the memory devices 402a-c may be separate hardened units. These hardened units may be distributed around a drilling rig 102 for redundancy and to increase the chance that data will survive a catastrophic event. The memory devices 402a-c may communicate with the memory interface unit 400 by wired or wireless means. In such embodiments, a beacon device 412 may be provided with each hardened memory unit. In certain embodiments, the memory interface unit 400 is not hardened, meaning that the hardened memory devices 402a-c may survive a catastrophic event while the memory interface unit 400 may not. Other variations as to what components are hardened or not hardened, or integrated or implemented as separate components, are possible and within the scope of the invention.

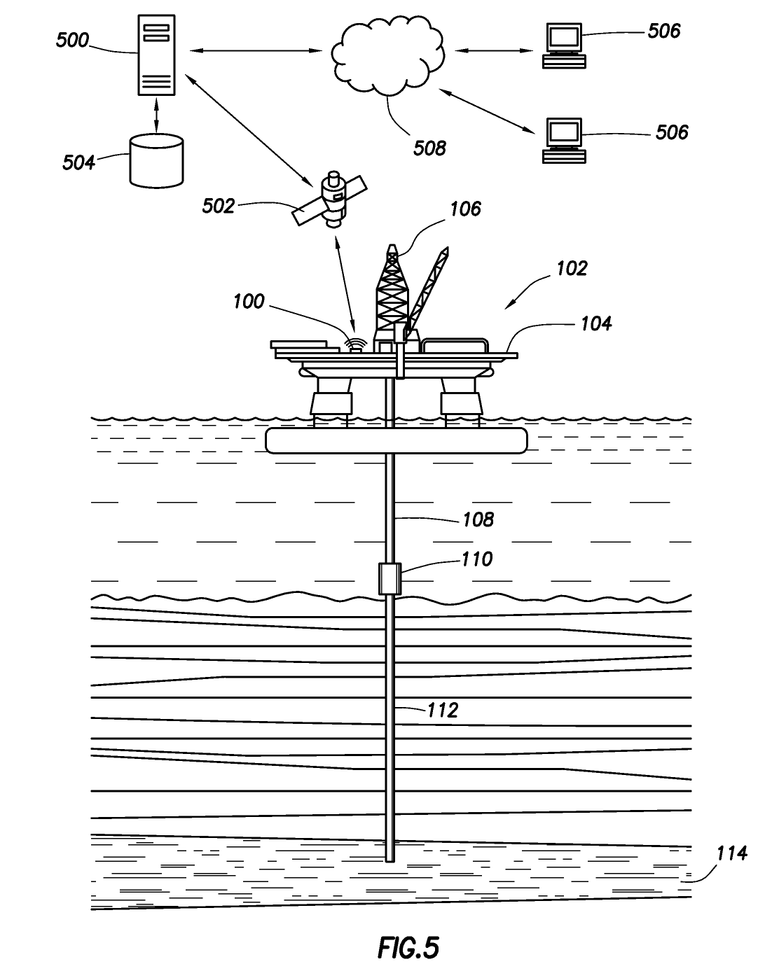

Referring to FIG. 5, in selected embodiments, the data recording system 100 may include functionality to enable communication with a remote site. This may allow a user or machine at a remote site (off the drilling rig 102) to download drilling data 416 from the data recording system 100 or log into and view drilling data 416 on the data recording system 100. Various different methods of communication, both wired and wireless, are possible.

In one embodiment, the data recording system 100 is configured to wirelessly communicate with the remote site over a telecommunications link, such as a satellite telecommunications link. In other embodiments, the data recording system 100 is configured to wirelessly communicate with the remote site over a cellular network, a long range Wi-Fi network, a wireless point-to-point connection, or the like. In yet other embodiments, the data recording system 100 is configured to communicate with a remote site over a wired telecommunications line, such as an underwater fiber-optic line.

The ability to communicate with the data recording system 100 from a remote site may provide various benefits. For example, in the event a catastrophic event, such as a fire or explosion occurs on the drilling rig 102, non-hardened equipment (e.g., non-hardened electronics, such as general purpose computers, servers, embedded systems, etc.) may be destroyed or damaged. Data on this equipment may be lost or inaccessible to local or remote personnel, making it difficult or impossible to analyze events that occurred on the drilling rig 102. Enabling direct communication with the data recording system 100 may allow the drilling data 416 to be downloaded and analyzed at a remote location without physically retrieving the data recording system 100 or visiting the drilling rig 102. In some cases, the remote location may have better resources and/or personnel to analyze the drilling data 416 and determine causes of the catastrophe.

In one contemplated embodiment, drilling data 416 is downloaded from the data recording system 100 to a remote server 500 by way of a satellite 502, where the data 416 may be stored in a database 504. The download may be initiated by a user, by an event detected on the drilling rig 102, or periodically at specified intervals. The server 500 may implement algorithms to analyze the data 416 or users may log into the server 500 to access and analyze the data 416. In certain embodiments, users may access data 416 in the database 504 from remote or local terminals 506 (e.g., computers 506 or workstations 506) over a network 508, such as a wide-area-network (WAN), local-area-network (LAN), virtual-private-network (VPN), the Internet, or the like.

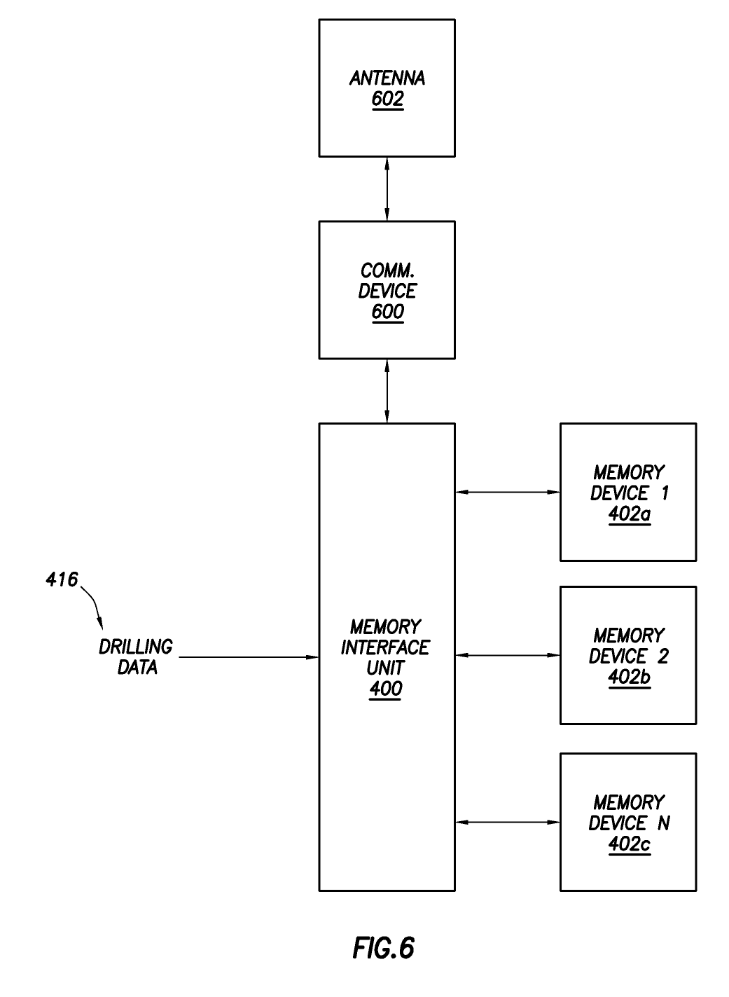

Referring to FIG. 6, the data recording system 100 may be configured in various different ways to enable communication between the data recording system 100 and a remote site. In one embodiment, a communication device 600 enables communication between a remote site and the memory interface unit 400. In certain embodiments, the communication device 600 includes a modulator (one-way communication) or modem (two-way communication) to enable point-to-point communication between the remote site and the data recording system 100. The communication device 600 may alternatively, or additionally, provide a network interface to enable communication over a network, such as a WAN, LAN, or the like. In general, the communication device 600 encodes carrier signals with the digital drilling data 416 for transmission to the remote site. In wireless applications, the communication device 600 may transmit and receive signals using an antenna 602.

Communicating with the data recording system 100 through the memory interface unit 400 may allow the remote site to access drilling data 416 on multiple hardened memory devices 402a-c using a single communication channel. In such embodiments, the memory interface unit 400 may be hardened since destruction or inoperability of the memory interface unit 400 may impair or terminate communication with some or all of the memory devices 402a-c. The illustrated embodiment is advantageous in that a single communication device 600 provides access to multiple memory devices 402a-c.

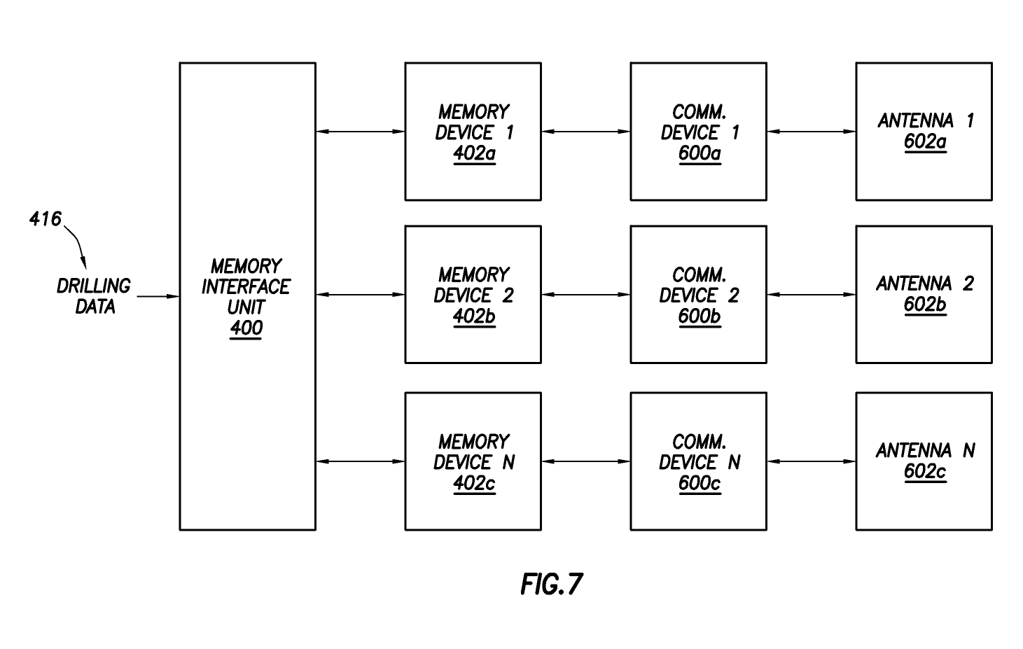

Referring to FIG. 7, in another embodiment, each hardened memory device 402a-c includes its own communication device 600a-c. In wireless applications, each communication device 600a-c includes an antenna 602a-c to send and receive signals. This configuration may allow each hardened memory device 402a-c to communicate with a remote site independently. Such a configuration may be advantageous in embodiments where the hardened memory devices 402a-c are distributed across a drilling rig 102 or in cases where communication from a centralized point is not feasible. Such a configuration may also be advantageous in embodiments where the memory interface unit 400 is not hardened and thus susceptible to damage. Providing a communication device 600a-c for each hardened memory device 402a-c may also provide redundancy and increase the probability that drilling data 416 can be accessed in the event of a disaster.

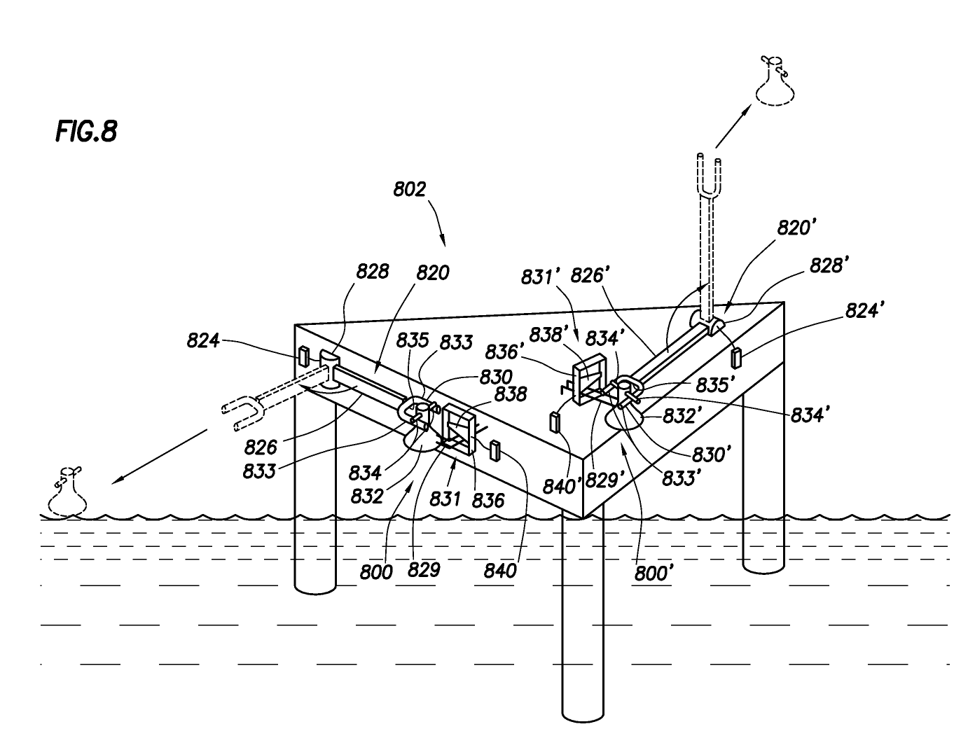

FIG. 8 depicts an alternate offshore drilling rig 802. As shown, the offshore drilling rig 802 is a jack-up drilling rig, but could be any offshore structure, such as the offshore drilling rig 102 of FIGS. 1-3 or any other offshore structure. The offshore drilling rig 802 is provided with two data recording systems 800, 800′. The data recording systems 800,800′ may be the same as the data recording system 100 (and/or its components, such as the hardened memory devices 402a-c) previously described with respect to FIGS. 1-7. As shown, the data recording systems 800,800′ are supported on a side and a surface of the offshore drilling rig 802 by a release mechanism 820,820′, respectively.

The release mechanisms 820,820′ are each pivotally mounted to the offshore drilling rig 802 for securing the data recording systems 800,800′ in position for recording information from the offshore drilling rig 802. Each release mechanism 820,820′ is rotationally extendable from the offshore drilling rig 802 for releasing the data recording systems 800,800′. The release mechanism 820 is pivotally mounted to the offshore drilling rig 802 to provide horizontal movement between a secured position adjacent the offshore drilling rig 802, and a released position extended therefrom as shown in dashed line. The release mechanism 820′ is pivotally mounted to the offshore drilling rig 802 to provide vertical movement between a secured position adjacent the offshore drilling rig 802, and a released position extended vertically therefrom as shown in dashed line. One or more data recording devices 800,800′ and release mechanisms 820,820′ may be positioned at various locations about the selected offshore drilling rig 802.

The pivotal movement of the release mechanisms 820,820′ may be used to launch the data recording systems 800,800′ a distance from the offshore drilling rig 802. The release mechanism 820,820′ may be provided with a release actuator 824,824′ for selectively releasing and/or activating the release mechanism 820,820′ to move between the secured and released positions. The release actuator 824,824′ may also be provided with force (e.g., spring) or power (e.g., hydraulic, pneumatic, etc.) capabilities to move the release mechanism 820,820′ with sufficient force to deploy the data recording systems 800,800′ a desired distance. The actuator 824,824′ may be configured to deploy the data recording systems 800,800′ to a position sufficiently distant from any potential threat which may damage the data recording systems 800,800′, such as fire, explosions, etc. The release mechanisms 820,820′, as depicted, are similar to a catapult type configuration, but may have a trebouchet or other type of release configuration.

The release mechanism 820,820′ includes an arm 826,826′ having a pivot 828,828′ at a mounted end and a cradle (or grip) 830,830′ at a release end thereof. The pivot 828,828′ may be a conventional joint for rotationally securing the arm 826,826′ to the offshore drilling rig 802. The arm 826,826′ may be an elongate member of a desired length and flexibility for providing the desired support and/or launching capabilities to the release mechanism 820,820′. The cradle 830,830′ has a pair of receiving arms 833,833′ with a pocket 835,835′ therebetween for releasably supporting the data recording system 800,800′ therein.

The data recording system 800,800′ may be provided with a body 832,832′ having support arms 834,834′ for supporting the data recording system 800,800′ in the cradle 830,830′. The shape of the body 832,832′ is a floatable buoy structure depicted as being larger on the bottom to facilitate operation and/or floatation, but can be of any shape or have buoyant material attached thereto or incorporated therein. The shape may be selected to, for example, allow the data recording systems 800,800′ to rest in the cradle 830,830′ during normal operations, slide freely out of the cradle 830,830′ during deployment, and/or remain at or near the surface of the water after deployment until recovered.

As shown, the support arms 834,834′ rest on the receiving arms 833,833′ of the cradle 830,830′. The data recording system 800,800′ may be receivable in the pocket 835,835′ and positioned therein until activation of the release mechanism 820,820′ by the actuator 824,824′. The data recording system 800,800′ may be supported by the cradle 830,830′ such that, upon activation, the data recording system 800,800′ is releasable from the pocket 835,835′. For example, as the release device 800,800′ gains momentum the data recording system 800,800′ may slide off the cradle 830,830′. The data recording system 800,800′ may be deployed a distance from the offshore drilling rig 802 by force of the movement of the release mechanism 820,820′ from its secured to its released position. A lock or other mechanism may optionally be provided to retain the data recording system 800,800′ in the cradle 830,830′ until release is desired.

Referring still to FIG. 8, disconnectors 831,831′ are also provided for selectively disconnecting the data recording systems 800,800′ from the offshore drilling rig 802. Each data recording system 800,800′ is coupled by a communication link 829,829′, such as cables, to the offshore drilling rig 802 as schematically depicted. The communication link 828,828′ may be used to allow communication between the offshore drilling rig 802 and the data recording systems 800,800′. As shown, each communication link 829,829′ is depicted as a pair of cables for providing a wired connection, but may be one or more links providing a wired or wireless connection.

The disconnector 831,831′ has a frame 836,836′ for movably supporting a blade 838,838′. The frame 836,836′ may be mounted to the offshore drilling rig 802 about the communication link 828,828′. The blade 838,838′ is slidably positionable in the frame 836,836′ between a raised (or retracted) and lowered (or severed) position. A disconnect actuator 840,840′ is provided to selectively release the blade 838,838′ from the retracted position so that it may fall to the severed position, thereby severing the communication link 829, 829′. The disconnector 831,831′ is depicted as a guillotine type mechanism for mechanically severing the communication links 829, 829′, but may be any mechanism capable of severing any physical connection to release the data recording system 800,800′ from any tethers or other devices which may physically attach the data recording system 800, 800′ to the offshore drilling rig 802,802′.

In operation, data is transferred to the data recording device 800,800′ via the communication links 829,829′. If a catastrophic event occurs on the offshore drilling rig 802, such as a blowout or fire, disconnect actuators 840,840′ and the release actuators 824,824′ may be automatically activated (e.g., by switches or computer commands) or manually activated (e.g., by rig personnel, such as the driller). The disconnect actuator(s) 840, 840′ and/or release actuator(s) 824,824′ may be activated remotely or locally activated upon occurrence of a catastrophic event, a predefined condition, and/or by command. Once initiated, the disconnect actuator(s) 840,840′ may be activated to sever the communication link(s) 829,829′, and the release actuator(s) 824,824′ activated to move the release mechanisms(s) 820,820′ from the secured to the release position. The disconnect actuator(s) 840,840′ disconnects the data recording device(s) 800,800′ from the drilling rig 802 and the release mechanism(s) deploy the data recording device(s) 800,800′. Once deployed, the data recording devices 800,800′ may be located and the data retrieved therefrom.

It will be appreciated by those skilled in the art that the techniques disclosed herein can be implemented for automated/autonomous applications via software configured with algorithms to perform the desired functions. These aspects can be implemented by programming one or more suitable general-purpose computers having appropriate hardware. The programming may be accomplished through the use of one or more program storage devices readable by the processor(s) and encoding one or more programs of instructions executable by the computer for performing the operations described herein. The program storage device may take the form of, e.g., one or more floppy disks; a CD ROM or other optical disk; a read-only memory chip (ROM); and other forms of the kind well known in the art or subsequently developed. The program of instructions may be “object code,” i.e., in binary form that is executable more-or-less directly by the computer; in “source code” that requires compilation or interpretation before execution; or in some intermediate form such as partially compiled code. The precise forms of the program storage device and of the encoding of instructions are immaterial here. Aspects of the disclosure may also be configured to perform the described functions (via appropriate hardware/software) solely on site and/or remotely controlled via an extended communication (e.g., wireless, internet, satellite, etc.) network.

The material disclosed herein may be embodied in other specific forms without departing from its essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A system for recording data associated with a drilling rig, the system comprising:
a hardened memory device; and
a memory interface unit to receive at least one data stream containing drilling data, extract the drilling data from the at least one data stream, and store the drilling data on the hardened memory device.

2. The system of claim 1, further comprising a beacon device, coupled to the hardened memory device, to aid in locating the hardened memory device.

3. The system of claim 1, further comprising a release device configured to release the hardened memory device from a structure upon occurrence of an event.

4. The system of claim 3, wherein the release device is manually actuatable to release the hardened memory device from the structure upon occurrence of an event.

5. The system of claim 3, wherein the release device is configured to automatically release the hardened memory device from the structure upon occurrence of an event.

6. The system of claim 3, wherein the release device comprises:
a disconnector for disconnecting the hardened memory device from the drilling rig; and
a release mechanism comprising an arm having a cradle for supporting the hardened memory device, the arm selectively movable between a secure position and a release position such that the hardened memory device is released a distance from the drilling rig.

7. The system of claim 6, wherein the disconnector comprises a guillotine cutter for severing a communication link between the hardened memory device and the drilling rig.

8. The system of claim 1, further comprising a communication device enabling communication with the hardened memory device from a remote location.

9. The system of claim 8, wherein the communication device enables communication with the hardened memory device through the memory interface unit.

10. The system of claim 8, wherein the communication device enables direct communication with the hardened memory device, bypassing the memory interface unit.

11. The system of claim 8, wherein the communication device comprises one of wired and wireless communication.

12. The system of claim 1, wherein the memory interface unit is hardened.

13. The system of claim 1, wherein the hardened memory device is one of a plurality of hardened memory devices, each storing redundant drilling data.

14. The system of claim 1, wherein the hardened memory device comprises a circular memory configured to overwrite less recent drilling data with more recent drilling data.

15. The system of claim 1, further comprising a battery backup to supply backup power to at least one of the memory interface unit and the hardened memory device.

16. The system of claim 1, wherein the at least one data stream comprises a plurality of data streams containing different types of drilling data.

17. The system of claim 16, wherein each of the different types of drilling data are stored in separate partitions on the hardened memory device.

18. The system of claim 16, wherein the different types of drilling data are multiplexed and stored together on the hardened memory device.

19. The system of claim 1, wherein the drilling data comprises at least one of: blowout preventer data, drilling flight recorder data, control system data, electronic drilling recorder data, pit volume totalizer data, sensor data, and wellsite information transfer specification data.

20. The system of claim 1, further comprising a human machine interface to enable a human to interact with the memory interface unit.

21. The system of claim 1, further comprising structures to enable at least one of the memory interface unit and the at least one hardened memory device to float in water.

22. A system for recording data associated with a drilling rig, the system comprising:
a hardened memory device;
a memory interface unit to receive at least one data stream containing drilling data, extract the drilling data from the at least one data stream, and store the drilling data on the hardened memory device; and
a communication device enabling communication with the hardened memory device from a remote location.

23. The system of claim 22, wherein the communication device enables communication with the hardened memory device through the memory interface unit.

24. The system of claim 22, wherein the communication device enables direct communication with the hardened memory device, bypassing the memory interface unit.

25. A system for recording data associated with a drilling rig, the system comprising:
a hardened memory device;
a memory interface unit to receive at least one data stream containing drilling data, extract the drilling data from the at least one data stream, and store the drilling data on the hardened memory device; and
a beacon device to aid in locating the hardened memory device; and
a release device configured to automatically release the hardened memory device from the drilling rig upon occurrence of an event.

26. The system of claim 25, wherein the release device is a hydrostatic release device.

27. The system of claim 25, wherein the memory interface unit is further configured to format the drilling data for storage on the hardened memory device.

28. The system of claim 25, wherein the release device comprises:
a disconnector for disconnecting the hardened memory device from the drilling rig; and
a release mechanism comprising an arm having a cradle for supporting the hardened memory device, the arm selectively movable between a secure position and a release position such that the hardened memory device is released a distance from the drilling rig.

29. The system of claim 28, wherein the disconnector comprises a guillotine cutter for severing a communication link between the hardened memory device and the drilling rig.
